(19) United States
(12) Patent Application Publication
(10) Pub. No.: US 2016/0016558 A1
(43) Pub. Date: Jan. 21, 2016

(54) DEBRIS REMOVAL SYSTEM FOR A VEHICLE

(71) Applicant: Steven James Santacroce, Cedar Rapids, IA (US)

(72) Inventor: Steven James Santacroce, Cedar Rapids, IA (US)

(21) Appl. No.: 14/336,823

(22) Filed: Jul. 21, 2014

(51) Int. Cl. B60S 1/68; B62D 65/02

(52) U.S. Cl. CPC B60S 1/68; B62D 65/024

(57) ABSTRACT

A debris removal system for vehicles is provided. The debris removal system may include an air compressor 10 that is attached to a vehicle. The present invention may further include a tubing 14. The tubing 14 may be attached to the air compressor 10 and may include a nozzle 16 at the end. The tubing 14 may be attached to the vehicle so that the nozzle 16 is directed right in front of at least one of the vehicles wheels. Therefore, when the air compressor 10 is activated, air may be directed from the compressor, through the tubing 14, and out of the nozzle 16, clearing any debris 36 that is in front the wheel.

### CROSS-REFERENCE TO RELATED APPLICATION

This application claims the benefit of priority of U.S. provisional application No. 61/825,367, filed May 20, 2013, the contents of which are herein incorporated by reference.

### BACKGROUND OF THE INVENTION

The present invention relates to the improvement of traction for vehicles and, more particularly, to a debris removal system to increase the traction of vehicles.

When traveling on hard surface routes on a two-wheeled, single track vehicle such as a motorcycle, or a four plus wheeled passenger, commercial, or racing automobile, loose debris in the path of the moving vehicle can greatly reduce traction when stopping or turning. Additionally, small volumes of water can cause hydroplaning at high rates of speed. Many current driving safety systems simply attempt to improve a vehicle's handling in poor road conditions, but fail to remove road hazards.

As can be seen, there is a need for a device that removes debris from the front of a vehicle.

### SUMMARY OF THE INVENTION

In one aspect of the present invention, a debris removal system comprises: a vehicle comprising at least one wheel; an air compressor attached to the vehicle; and a tubing connected to the air compressor and comprising a nozzle, wherein the nozzle is directed to deliver air from the air compressor in front of the at least one wheel.

In another aspect of the present invention, a method of constructing a vehicle debris removal system comprises: attaching an air compressor to a vehicle; attaching a tubing comprising a nozzle to the air compressor; and directing the nozzle in front of at least one wheel of the vehicle.

These and other features, aspects and advantages of the present invention will become better understood with reference to the following drawings, description and claims.

### BRIEF DESCRIPTION OF THE DRAWINGS

FIG. 1 is a perspective view of the present invention, shown in use;

FIG. 2 is a detailed perspective view of the present invention;

FIG. 3 is a front view of the present invention;

FIG. 4 is a top view of the present invention;

FIG. 5 is a side view of the present invention, illustrating compressed air blowing debris;

FIG. 6 is a flow chart of the present invention, illustrating the system configuration, using an electric compressor;

FIG. 7 is a flow chart of the present invention, illustrating the system configuration, using a mechanically driven compressor; and

FIG. 8 is a perspective view an alternate embodiment of the present invention, shown in use

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a compressed air vehicle safety control apparatus for avoiding loss of traction. The present invention may remove road debris and small volumes of water by directing high velocity compressed air at the road surface immediately in front of the wheels of a vehicle, thereby eliminating or reducing the possibility of hydroplaning and loss of traction while cornering or stopping.

The compressed air may be produced by an air compressing system. The air compressing system may be powered either by vehicle's electrical or mechanical systems. For example, the compressor may be powered by engagement with the vehicle such as the belt drive, shaft drive, gear drive, friction drive, magnetic drive or other power supply derived from the operation or movement of the vehicle. The compressed air may be contained in a reservoir and directed through high pressure tubing to a nozzle directed in front of the tires on the vehicle. In the case of granule debris like sand, the compressed air may propel the debris out of the path of the vehicle. In order to prevent hydroplaning, compressed air may disrupt surface tension of standing water in order to increase contact area between tire track and road.

The present invention may be applied to motorcycles, scooters, bicycles, mopeds, and passenger vehicles including but not limited: to sedans, SUV's, crossovers, trucks, buses, commercial semi trucks, emergency vehicles, and the like. Additionally, the system may be applied to race vehicles including but not limited to: motorcycles, cars, trucks, buses, high-performance dragsters, and the like. Additionally, the system may be used on aircraft landing gear for clearing minor runway debris. Additionally, this device may be used at higher pressures for clearing potentially dangerous objects off the metal tracks that a train may travel on.

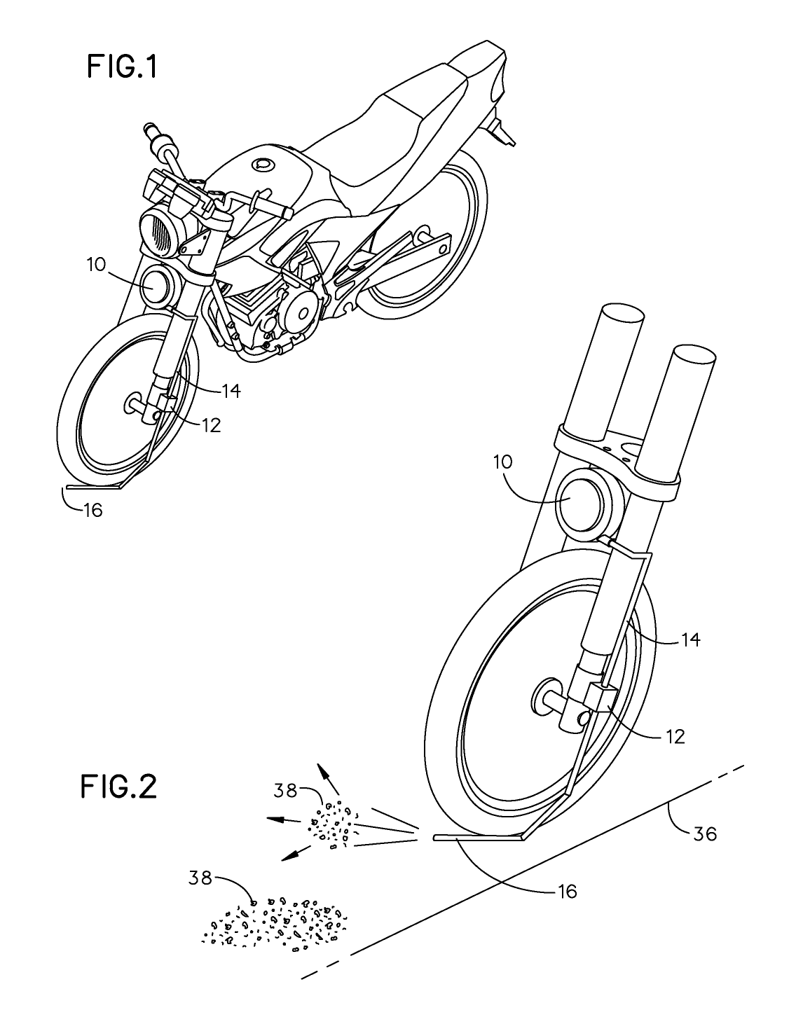

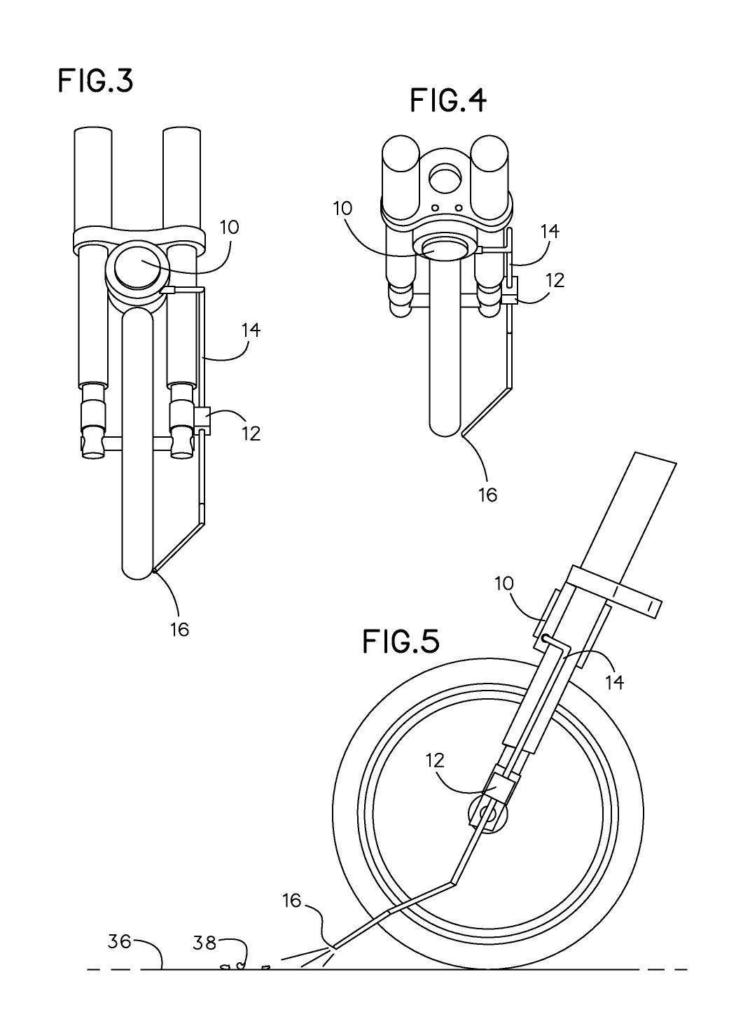

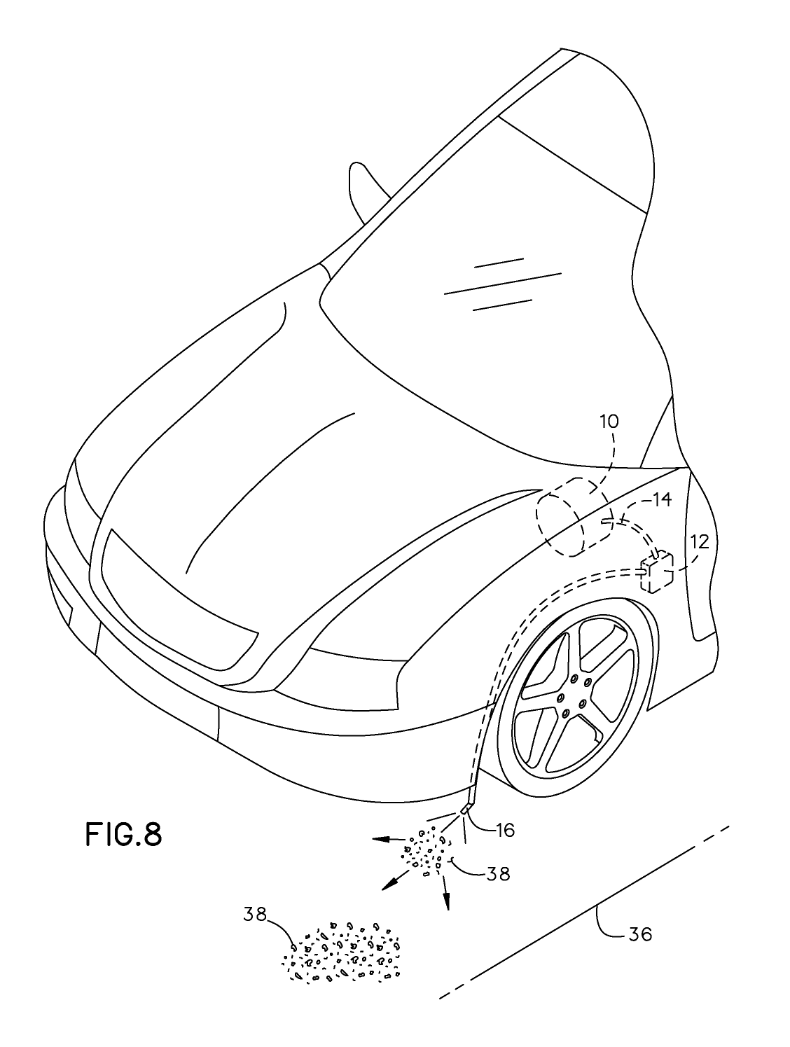

Referring to FIGS. 1 through 8, the present invention includes an air compressor 10 that is attached to a vehicle. The present invention may further include a tubing 14. The tubing 14 may be attached to the air compressor 10 and may include a nozzle 16 at the end. The tubing 14 may be attached to the vehicle so that the nozzle 16 is directed right in front of at least one of the vehicles wheels.

Therefore, when the air compressor 10 is activated, air may be directed from the compressor, through the tubing 14, and out of the nozzle 16, clearing any debris 38 that is in front the wheel.

The air compressor 10 may be an electric compressor 28 or a mechanical compressor 30. The air compressor 10 may be powered either directly by the vehicles drive system (e.g. drive belts, chains), a separate electrical motor powered by an electrical system on the vehicle, or by mechanical engagement with the vehicle, including but not limited to: the belt drive, shaft drive, gear drive, friction drive, magnetic drive, or other power source derived from the operation or movement of the vehicle.

The air compressor 10 may intake outside air, which may then be directed to a reservoir. Air pressure may increases in the reservoir. Pressurized air may then be directed from the reservoir and through the high-pressure tubing 14 to a junction block 12. The junction block 12 may include one input (from the reservoir or compressor) and as many outputs as the number of wheels on the vehicle to which additional tubing 14 is attached. At the end of the tubing 14 the nozzle 16 may ultimately directed the compressed air to the road surface 36. When the operator of a vehicle spots a potential hazard in the road, they may use a switch 18 to initiate a manually controlled blast of air to remove the debris 38.

The air reservoir may hold a volume of around 1 gallon. However, the volume may vary from about 0.05 gallons to about 3 gallons or more. The reservoir may be made of aluminum, steel, brass, iron, any other sort of metal. Any sized reservoir may be used depending on vehicle type and available space.

The junction box 12 may be about 2″×2″×0.50″ or any dimensions that may be appropriate. The junction box 12 may be made from copper, steel, carbon fiber, high-density plastic, any other type of metal or plastic. The junction box 12 may include an input stem for receiving air from reservoir. Further, the junction box 12 may include the same amount of output stems as the number of wheels on the vehicle.

The tubing 14 may range in diameter from about 2 inches to about 0.125 inches, such as about 0.5 inches. The tubing 14 may be made of plastic, copper, steel, brass, carbon fiber, rubber, or any other type of metal or plastic. The tubing may vary in length between less than one inch and more than 12 feet. A length of the tubing 14 may be used to connect the compressor 10 to the reservoir and another length may be used to connect the reservoir to a junction block 12. Additional tubing is used from the junction block 12 to the wheel.

The nozzle 16 or jet may include a piece used to direct air to the road surface 36. In certain embodiments, the shape of the nozzle 16 may be conical. The nozzle 16 contains a center-drilled hole for passage of air. Material of construction may be copper or brass, although the nozzle 16 may be constructed out of any type of polymer, metal, carbon fiber, glass. Different types of nozzles 16 may be used to offer different air pressures/speeds of output based on consumer desires.

In certain embodiments, the present invention may further include a tire inflation attachment. The tire inflation attachment may include an extra piece of hose which may vary in length from about 1′ to about 50′ or more. The hose may be constructed from any flexible plastic or rubber material. The hose may include a quick release fitting to mount to a quick disconnect 32 disposed on the tubing 16 in between the nozzle and the air compressor 10. The opposite end may include an adapter for filling the tire.

The present invention may further include a control panel comprising a computer 24, for controlling the system. The manual switch 18 may be operatively connected to the control panel. Further, a dial may be connected to the control panel and may be used to change the system status from On, Off and Auto. The present invention may further include system status indicators which may indicate current system pressure, as well as the system mode (On/Off/Auto). For example, the status indicators may be displayed to a user from an LCD screen.

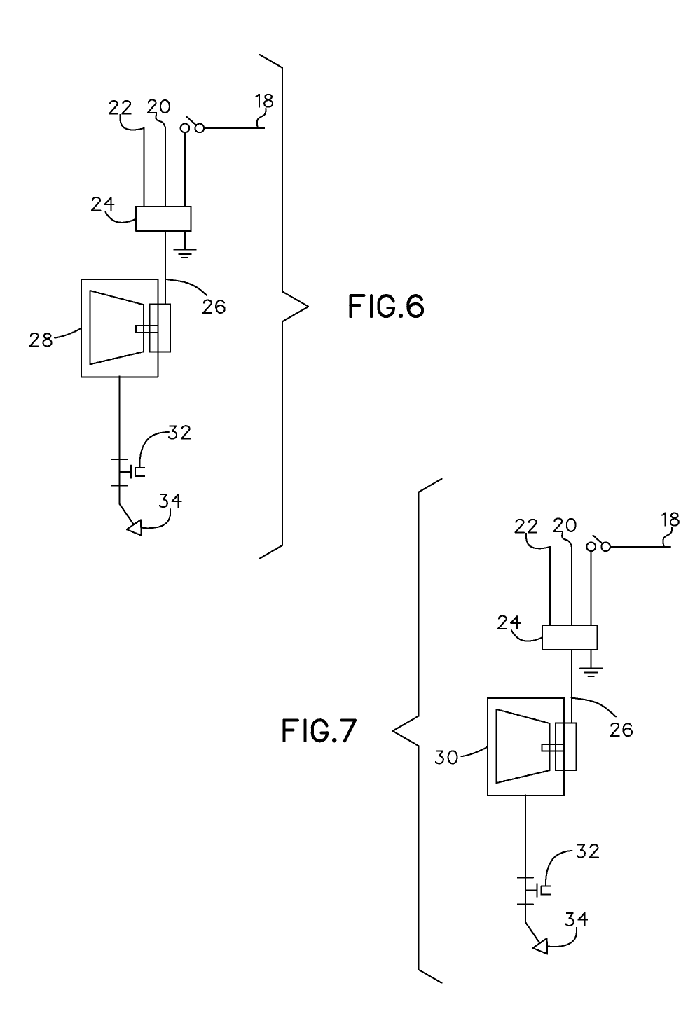

As illustrated in FIGS. 6 and 7, the switch 18 and/or dial, a vehicle data input 20, and the vehicles power 22 may be connected to the computer 24. The vehicle data input 20 may deliver data regarding the vehicle, such as data regarding the vehicles speed, acceleration, radius of turning, windshield wipers, and the like. The computer 24 may be connected to either an electric compressor 28, or a mechanical compressor 30, via a wired connection 26. The wired connection 26 may deliver power to the compressors 38, 30 while the computer 24 may determine when to deliver the power to the compressor 28, 30 based on the vehicle data input 20. When the power is delivered to the compressor 28, 30, air may be pumped out of the adjustable nozzle 34 or alternatively diverted to a quick disconnect 32 in order to fill the tires of the vehicle.

The present invention may be integral with two types of vehicles. The two types of vehicles may include those with, and those without windshields and windshield wipers. In all cases, the system is designed to be in ready mode, as long as the vehicle's drive system (internal combustion, electrical, or otherwise) is active.

When used with a vehicle lacking a windshield and wipers (motorcycles), three system modes may exist: Auto, Off, and On. In auto mode, the control panel may be programmed to operate above a predetermined threshold speed. Therefore, the system may not expel air at unnecessarily low rates of speed, perhaps less than 5 mph (i.e. in a parking lot/traffic jam) where such a system would not aid traction. Additionally, and also in Auto mode, the system may be programmed to engage specifically during turning, stopping, or accelerating maneuvers (i.e. whenever linear acceleration is not constant and in the forward direction). Secondly, in On mode, the system may remain operational regardless of the direction of accelerating (always expelling air) as long as vehicle speed surpasses the predetermined threshold speed. Lastly, in Off mode, the system may remain idle and may only respond to inputs from the manual switch 18.

For a vehicle that has a windshield and windshield wipers, the aforementioned modes may exist in a similar configuration (On, Off, Auto). The system may determine its operational status based on a composite calculation of both wiper speed status and vehicle speed. For example, if the wipers are off or in intermittent mode, the safety system may be idle, unless overridden by the manual switch 18. The system may be turned on if speed and wiper status meet or exceed predetermined set points and if not disengaged by operator. Further, the system may be turned on if the wipers are on high speed and vehicle speed is greater than zero. However, if the wipers are in continuous mode but not high speed mode and the vehicle exceeds a speed threshold the system may be on.

A method of making the present invention may include the following. The components of the system may be mounted and contained within the vehicle. Appropriate mounting hardware may be used to secure each piece of the system to the vehicle. Such mounting techniques (and various materials used to produce them) may include brackets, braces, ties, cords, various shaped clamps, or even adhesives or magnetism may be used.

The system may be attached to the desired vehicle in such a way that all components are mounted in locations that do not interfere with normal vehicle operation. The components may be interconnected by high-pressure tubing to facilitate the undisturbed transference of high-velocity air from compressor, to reservoir, to junction block, and finally to corresponding wheel jet. In the case of an electrically powered compressor, appropriate connections may be made between the systems power input wires, sensors and the existing electrical system of the vehicle. In the case of mechanically engaged means of compressing air, a secure linkage is made to the vehicles drive system or other powering means of vehicle use that result in motion.

A method of using the present invention may include the following. The operator of a vehicle may either manually turn the compressor on or set the system in one of three different modes discussed above. In Automatic mode, the system is fully automated and no operator input is required. In On mode the system is on at all times, again no input is required. In Off mode, the operator may choose to use the on-demand blast switch upon seeing a hazard in the road that the present invention is designed to eliminate.

It should be understood, of course, that the foregoing relates to exemplary embodiments of the invention and that modifications may be made without departing from the spirit and scope of the invention as set forth in the following claims.

What is claimed is:

1. A debris removal system comprising:
a vehicle comprising at least one wheel;
an air compressor attached to the vehicle; and
a tubing connected to the air compressor and comprising a nozzle, wherein the nozzle is directed to deliver air from the air compressor in front of the at least one wheel.

2. The debris removal system of claim 1, further comprising a switch operatively attached to the air compressor.

3. The debris removal system of claim 1, further comprising an air reservoir connected to the tubing in between the air compressor and the nozzle.

4. The debris removal system of claim 1, further comprising a junction box connected to the tubing in between the air compressor and the nozzle.

5. The debris removal system of claim 1, wherein the vehicle comprises a plurality of wheels.

6. The debris removal system of claim 4, further comprising a junction box comprising an input and a plurality of outputs, wherein the input receives a tubing connected to the air compressor, and wherein a plurality of tubing extends from the plurality of outputs for each of the plurality of wheels of the vehicle.

7. The debris removal system of claim 1, further comprising a control panel comprising a computer, and at least one vehicle data input connected to the control panel, wherein a delivery of air from the air compressor is delivered based on the at least one vehicle data input.

8. A method of constructing a vehicle debris removal system comprising:
attaching an air compressor to a vehicle;
attaching a tubing comprising a nozzle to the air compressor; and
directing the nozzle in front of at least one wheels of the vehicle.

9. The method of claim 7, further comprising the step of connecting a junction box to the tubing in between the air compressor and the nozzle, wherein the junction box comprises an input and a plurality of outputs.

10. The method of claim 8, further comprising the step of connecting a plurality of tubing to the plurality of outputs and directing the each nozzle in front of a plurality of wheels of the vehicle.
